(19) United States
(12) Patent Application Publication
(10) Pub. No.: US 2026/0251626 A1
(43) Pub. Date: Aug. 27, 2026

(54) MANAGEMENT SYSTEM AND MANAGEMENT METHOD FOR LIQUID CHROMATOGRAPH

(71) Applicant: SHIMADZU CORPORATION, Kyoto (JP)

(72) Inventor: Rika OGAMI, Kyoto-shi (JP)

(73) Assignee: SHIMADZU CORPORATION, Kyoto (JP)

(21) Appl. No.: 19/449,187

(22) Filed: Jan. 14, 2026

(30) Foreign Application Priority Data
Feb. 25, 2025 (JP) 2025-027863

(51) Int. Cl. G01N 30/86; G01N 30/02; G01N 30/72; G01N 30/88

(52) U.S. Cl. CPC G01N 30/8658; G01N 30/7233; G01N 30/8651; G01N 30/8679; G01N 2030/027; G01N 2030/8804

(57) ABSTRACT

One aspect of the present invention is a system for acquiring information used when determining analysis conditions for operating an LC apparatus, comprising: a first storage unit for saving a first analysis result file containing a first analysis result acquired by subjecting a predetermined sample containing one or a plurality of compounds to LC analysis under a first analysis condition; a second storage unit for saving a second preparative result file containing a second analysis result acquired by subjecting a predetermined sample containing one or a plurality of compounds to LC analysis under a second analysis condition in which a mobile phase flow rate or a sample injection amount is larger than in the first analysis condition; a search unit for searching for the second analysis result associated with the same compound as a compound associated with the first analysis result; an association information creation unit for creating association information associating the first analysis result with the second analysis result for each compound based on a search result; and a display processing unit for displaying the association information.

### TECHNICAL FIELD

The present invention relates to a system and a method for managing a liquid chromatograph apparatus, and particularly to a system and a method for managing a preparative liquid chromatograph apparatus for fractionating components in a sample.

### BACKGROUND ART

In fields such as pharmaceutical research, development, or manufacturing, preparative liquid chromatographs (hereinafter, a “liquid chromatograph” may be referred to as “LC”) are widely used to fractionate and purify target components (compounds) from samples containing chemically synthesized components. In order to accurately and efficiently fractionate a target compound in a sample using a preparative LC, it is important to appropriately set preparative conditions such as the type of column, the type of mobile phase, the flow rate or flow velocity of the mobile phase, and gradient conditions (temporal change in the concentration of the mobile phase) according to the compound.

When searching for preparative conditions in a preparative LC, a technique called scale-up is sometimes used. In this technique, optimal analysis conditions are determined by LC analysis using a column with a smaller capacity than a preparative column (a normal analytical column), that is, LC analysis on an “analytical scale,” and these analysis conditions are adjusted to suit LC analysis using a large-capacity preparative column, that is, LC analysis on a “preparative scale.” Although the determination of preparative conditions by such scale-up is generally handled by a person having sufficient knowledge and experience regarding LC, the work is still quite troublesome and requires time and effort. In contrast, systems (software) have conventionally been provided that enable even a person in charge (user) with poor knowledge of LC to determine appropriate preparative conditions (see Non-Patent Literature 1).

### CITATION LIST

### Patent Literature

[Patent Literature 1] International Publication No. WO 2016/021715

### Non-Patent Literature

[Non-Patent Literature 1] “Reversed-phase purification automatic scale-up system ASAPrep”, [Online], [Searched on Feb. 21, 2025], Shimadzu Corporation, Internet <URL: https://www.an.shimadzu.co.jp/products/liquid-chromatography/preparative-hplc/asaprep/index.html>

### SUMMARY OF INVENTION

### Technical Problem

In “ASAPrep optimized purification” included in the system described in Non-Patent Literature 1, it is possible to calculate the initial concentration of an organic mobile phase under preparative conditions that yield a desired result on a preparative scale, from retention time information of a target compound obtained by executing analytical scale LC analysis, using a calculation formula registered in software in advance. Then, it is possible to determine gradient conditions based on this calculated initial concentration of the organic mobile phase. To obtain a calculation formula indicating the relationship between the retention time in LC analysis and the initial concentration of the organic mobile phase, for example, the method described in Patent Literature 1 can be used.

According to the description of Patent Literature 1, a calculation formula for scaling up from an analytical scale to a preparative scale can be obtained based on LC analysis data obtained by performing analytical scale LC analysis on a standard sample containing a target compound, and LC preparative data obtained by performing preparative scale LC analysis differing from the analytical scale (usually differing in column capacity, etc.) on the same standard sample. In other words, obtaining this calculation formula requires a considerable amount of data acquired by performing LC analysis under different conditions for each of a plurality of compounds. Further, since this calculation formula depends on the type of column used and the like, if it is desired to perform fractionation using a column of a type different from the column corresponding to an already registered calculation formula, it is necessary to create a new calculation formula based on LC analysis results on a preparative scale using the column to be used. Such work is usually performed by an engineer of an apparatus manufacturer or, in some cases, an administrator having specialized knowledge on the apparatus user side, but there has been a problem that the work is quite complicated, workability is poor and time-consuming, or work errors are likely to occur.

The present invention has been made in view of such problems, and a main object thereof is to provide a management system and a management method for an LC capable of simplifying work for acquiring a calculation formula used for determining appropriate preparative conditions by scale-up or information corresponding thereto, improving workability thereof, and reducing work errors.

### Solution to Problem

One aspect of a management system for a liquid chromatograph according to the present invention made to solve the above problems is a management system for acquiring information used when determining analysis conditions for operating a liquid chromatograph apparatus, comprising: a first storage unit configured to save one or a plurality of first analysis result files containing a first analysis result acquired by subjecting a predetermined sample containing one or a plurality of compounds to liquid chromatograph analysis under a first analysis condition; a second storage unit configured to save a plurality of second analysis result files containing a second analysis result acquired by subjecting a predetermined sample containing one or a plurality of compounds to liquid chromatograph analysis under a second analysis condition in which a mobile phase flow rate or a sample injection amount is larger than in the first analysis condition; a search unit configured to search for the second analysis result associated with the same compound as a compound associated with the first analysis result in the first analysis result file saved in the first storage unit, from the second analysis result files saved in the second storage unit; an association information creation unit configured to create association information associating the first analysis result with the second analysis result or associating the first analysis result file with the second analysis result file, for each compound, based on a search result by the search unit; and a display processing unit configured to display the association information on a display screen.

Further, one aspect of a management method for a liquid chromatograph according to the present invention made to solve the above problems is a management method for acquiring information used when determining analysis conditions for operating a liquid chromatograph apparatus using a computer, wherein the computer executes: a first step of saving one or a plurality of first analysis result files containing a first analysis result acquired by subjecting a predetermined sample containing one or a plurality of compounds to liquid chromatograph analysis under a first analysis condition; a second step of saving a plurality of second analysis result files containing a second analysis result acquired by subjecting a predetermined sample containing one or a plurality of compounds to liquid chromatograph analysis under a second analysis condition in which a mobile phase flow rate or a sample injection amount is larger than in the first analysis condition; a third step of searching for the second analysis result associated with the same compound as a compound associated with the first analysis result in the first analysis result file, from the second analysis result files; a fourth step of creating association information associating the first analysis result with the second analysis result or associating the first analysis result file with the second analysis result file, for each compound, based on a result of the search; and a fifth step of displaying the association information on a display screen.

### Advantageous Effects of Invention

In one aspect of the management system and the management method for a liquid chromatograph according to the present invention, work of searching for a first analysis result and a second analysis result for the same compound acquired under mutually different analysis conditions and associating and displaying them is automated, making it unnecessary for a person in charge to perform such work personally. Further, the person in charge can easily compare the first analysis result and the second analysis result for the same compound based on the association information displayed on the display screen. Thereby, according to the present invention, it is possible to simplify the work of the person in charge when acquiring a calculation formula used for determining appropriate preparative conditions by scale-up or information corresponding thereto, improve work efficiency thereof, reduce work errors, and enable setting of more appropriate preparative conditions.

### BRIEF DESCRIPTION OF DRAWINGS

FIG. 1 is a schematic block configuration diagram showing an example of a preparative condition determination system including an embodiment of an LC management system according to the present invention.

FIG. 2 is a schematic block configuration diagram showing an example of a preparative LC apparatus using preparative conditions determined by the LC management system according to the present invention.

FIG. 3 is a functional block configuration diagram of a preparative management unit in FIG. 1.

FIG. 4 is a flowchart showing an example of an operation procedure and a processing procedure when obtaining a calculation formula for determining preparative conditions in the LC management system of the present embodiment.

FIG. 5 is a diagram showing an example of an analysis data selection screen.

FIG. 6 is a diagram showing an example of a preparative condition calculation screen showing a state in which analysis data is selected.

FIG. 7 is a diagram showing an example of a compound table after preparative data has been searched for on the preparative condition calculation screen.

FIG. 8 is a diagram showing a part (right part) of a screen after calculation of a calculation formula has been performed on the preparative condition calculation screen. FIG. 9 is a diagram showing another example of the compound table after preparative data has been searched for on the preparative condition calculation screen (a case where three or more pieces of preparative data exist for one compound).

FIG. 10 is a diagram showing an example of a context menu.

FIG. 11 is a diagram showing an example of display on the compound table when a preparative retention time is changed on the compound table.

FIG. 12 is a diagram showing an example of a preparative data selection screen displayed when changing a preparative data file.

FIG. 13 is a diagram showing an example of a table preparative condition calculation screen including a compound table when two compound groups, a standard compound group and a hydrophobic compound group, are set.

FIG. 14 is a diagram showing a display area on the right side of the compound table shown in FIG. 13.

FIG. 15 is a diagram showing an example of a graph showing gradient conditions during preparative LC execution and a calculation formula used for determining the same.

### DESCRIPTION OF EMBODIMENTS

Hereinafter, an embodiment of an LC management system and an LC management method according to the present invention will be described in detail with reference to the accompanying drawings.

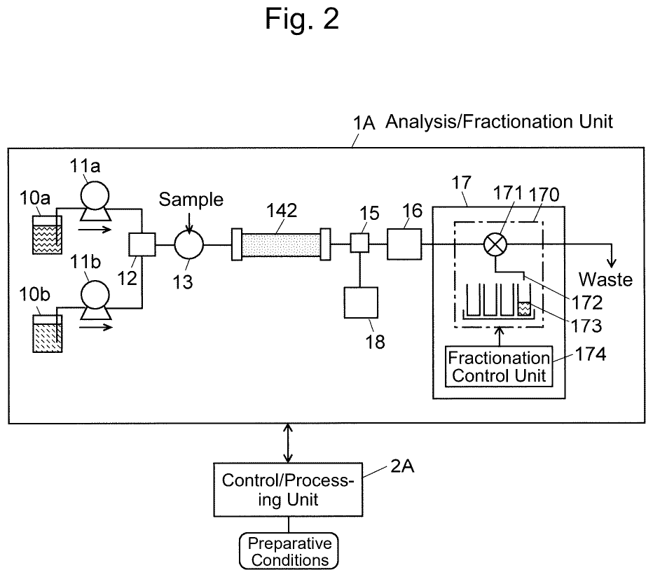

The LC management system and the LC management method according to the present invention are typically used to determine preparative conditions used when performing fractionation and purification of a specific target compound in a preparative LC apparatus. Therefore, first, a configuration of a preparative LC apparatus and an example of an operation of fractionation and purification using preparative conditions in the preparative LC apparatus will be schematically described with reference to FIG. 2.

### Configuration and Operation of Preparative LC Apparatus

FIG. 2 is a block configuration diagram of an example of a preparative LC apparatus. This preparative LC apparatus includes an analysis/preparative unit 1A and a control/processing unit 2A. The analysis/preparative unit 1A includes first and second mobile phase containers 10a and 10b, first and second liquid sending pumps 11a and 11b, a mixer 12, an injector 13, a preparative column 142, a splitter 15, a first detector 16, a fraction collector 17, and a second detector 18.

The first liquid sending pump 11a sucks and delivers a first mobile phase which is an aqueous mobile phase such as water or a buffer solution prepared in the first mobile phase container 10a. The second liquid sending pump 11b sucks and delivers a second mobile phase which is an organic mobile phase such as acetonitrile prepared in the second mobile phase container 10b. The first and second mobile phases are mixed by the mixer 12 and supplied to the preparative column 142 via the injector 13. Both the first and second liquid sending pumps 11a and 11b operate under the control of the control/processing unit 2A such that their flow rates change over time, whereby high-pressure gradient liquid sending in which the component ratio of the first and second mobile phases changes temporally is performed. However, a single mobile phase of either one may be used without performing gradient liquid sending, or a mobile phase in which the mixing ratio of two mobile phases is temporally constant may be used.

As the preparative column 142, a column having a larger inner diameter than a general analytical column, that is, a large-capacity column is used so that a large amount of mobile phase can flow. In a state where the mobile phase is supplied to the preparative column 142 at a constant flow rate, the injector 13 injects a predetermined amount of liquid sample selected by an autosampler (not shown) into the mobile phase at a predetermined timing. The injected liquid sample is introduced into the preparative column 142 along with the mobile phase, and while passing through the column 142, various compounds in the liquid sample are temporally separated and eluted from an outlet end thereof. The eluate is branched by the splitter 15, and most of it is introduced into the first detector 16, and a small part is introduced into the second detector 18.

As the first detector 16, for example, a non-destructive detector such as an ultraviolet-visible spectrophotometric detector is used. On the other hand, as the second detector 18, a mass spectrometer which is a destructive detector is used. The first detector 16 and the second detector 18 each detect compounds in the eluate and send detection signals to the control/processing unit 2A and a preparative control unit 174 described later. The eluate that has passed through the first detector 16 is introduced into the fraction collector 17. The fraction collector 17 includes a preparative unit 170 including a preparative valve 171, a preparative nozzle 172, a preparative container 173, and the like, and the preparative control unit 174, and fractionates and collects the eluate containing the target compound.

The control/processing unit 2A is configured by a computer including a CPU (Central Processing Unit), a RAM (Random Access Memory), a storage, and the like. The control/processing unit 2A separates compounds in the liquid sample and fractionates the eluate containing one or a plurality of compounds by controlling ON/OFF operations and liquid sending speeds of the liquid sending pumps 11a and 11b, sample injection operation in the injector 13, operation of the preparative control unit 174, and the like while monitoring detection signals from the first and second detectors 16 and 18 according to preset preparative conditions. The preparative conditions can include one or a plurality of the type of mobile phase, the flow velocity (flow rate) of the mobile phase, the injection amount of the sample, the temperature of the column, gradient conditions, and the like. Further, the preparative conditions can also include the type of column, the size of the column, and the like.

In the fraction collector 17, the preparative control unit 174 has a function of controlling the operation of the preparative unit 170 based on a detection signal (chromatogram signal) obtained by the first detector 16 or the second detector 18, but this function may be built into the control/processing unit 2A.

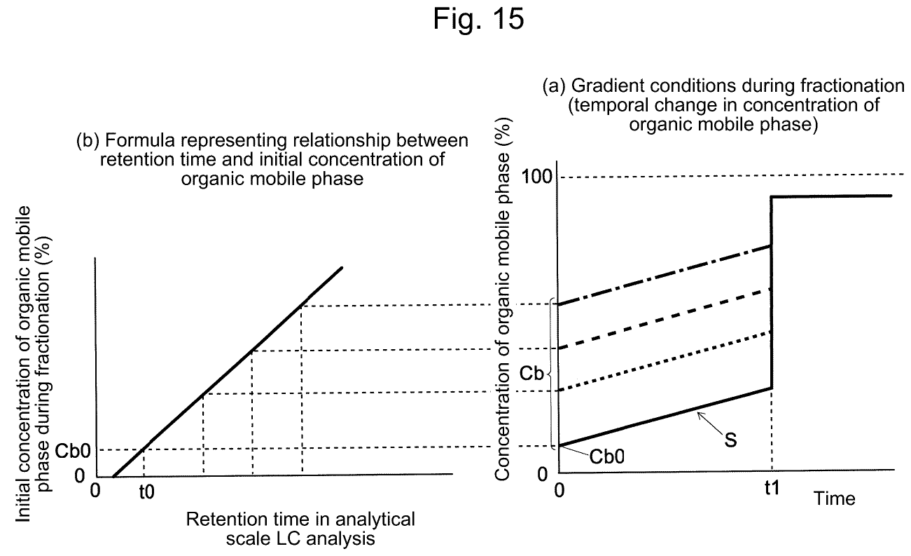

In this preparative LC apparatus, when fractionating and purifying a specific target compound in a sample, the control/processing unit 2A controls the operation of each unit according to preparative conditions including gradient conditions as shown in FIG. 15(a). In these gradient conditions, the concentration of the organic mobile phase gradually increases from an initial concentration Cb at a constant slope S over time. Then, at a predetermined time t1, the concentration of the organic mobile phase increases rapidly to, for example, 90%, and is thereafter maintained constant. The slope S of the change in the mobile phase is constant so that the compound to be fractionated is appropriately separated from other compounds and so that retention times (elution times) are generally similar for various target compounds. On the other hand, the initial concentration Cb of the organic mobile phase is changed according to the type of the target compound, more precisely, according to the retention time of the target compound in the analytical scale LC analysis. In FIG. 15(a), changes in the concentration of the mobile phase corresponding to different target compounds are indicated by dotted lines, broken lines, dashed-dotted lines, etc.

In order to fractionate a target compound in a sample with a high recovery rate and high purity, it is important to appropriately set the initial concentration Cb of the organic mobile phase (hereinafter, this initial concentration of the organic mobile phase may be simply referred to as “mobile phase initial concentration”) according to the retention time which is the LC analysis result of the target compound. In the management system for LC according to the present invention, in order to appropriately determine the mobile phase initial concentration, a calculation formula which is an approximate linear expression representing the relationship between the retention time in analytical scale LC analysis and the mobile phase initial concentration as shown in FIG. 15(b) is provided, so that the mobile phase initial concentration can be determined based on this calculation formula.

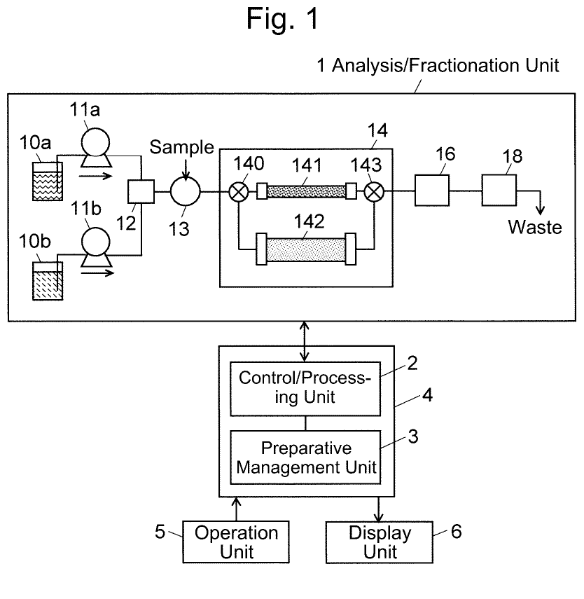

Next, an LC management system and an LC management method according to an embodiment of the present invention, and a computer program used for realizing the method will be described. [Configuration of Preparative Condition Determination System] FIG. 1 is a schematic block configuration diagram showing an example of a preparative condition determination system including the LC management system of the present embodiment. In the figure, components identical or corresponding to those of the system in FIG. 2 already described are denoted by the same reference numerals to clarify the correspondence. This system includes an analysis/preparative unit 1, a control/processing unit 2, a preparative management unit 3, an operation unit 5, and a display unit 6. In the analysis/preparative unit 1, main differences from the analysis/preparative unit 1A in FIG. 2 are that the preparative column 142 is replaced with a separation column unit 14 including a plurality of columns, that there is no fraction collector 17, and that the second detector 18 is provided at a subsequent stage of the first detector 16. In this analysis/preparative unit 1, although LC analysis using the preparative column 142 is performed, fractionation of the eluate is not executed, so the fraction collector 17 is unnecessary. Further, since the eluate is not fractionated, the second detector 18 is provided at the subsequent stage of the first detector 16, but this second detector 18 may be arranged via a splitter 15 provided at a preceding stage of the first detector 16 as shown in FIG. 2.

The separation column unit 14 is composed of multiple types of columns including an analytical column 141 used for analytical scale LC analysis and a preparative column 142 used for preparative scale LC analysis, and flow path switching valves 140 and 143. As described above, usually, as the analytical column 141, a column having a lower capacity, specifically a smaller inner diameter, than the preparative column 142 is used. That is, in this system, by switching the flow path using the flow path switching valves 140 and 143, it is possible to carry out LC analysis using different types of columns, including capacity. Note that, although only two mobile phase containers 10a and 10b are described in FIG. 1, a configuration capable of switching between different types of mobile phases may be adopted.

The control/processing unit 2 carries out LC analysis on compounds in a liquid sample under various analysis (and preparative) conditions and collects LC analysis results by controlling ON/OFF operations and liquid sending speeds of the liquid sending pumps 11a and 11b, sample injection operation in the injector 13, flow path switching operation by the flow path switching valves 140 and 143, and the like while monitoring detection signals from the first and second detectors 16 and 18 according to various preset analysis conditions. On the other hand, the preparative management unit 3 determines optimal preparative conditions for fractionating a target compound based on the analytical scale LC analysis result and the preparative scale LC analysis result. The entity of the control/processing unit 2 and the preparative management unit 3 is a computer 4 including a CPU, a RAM, a storage, and the like, and their functions are embodied by executing a program installed in the storage on the computer 4 in the computer 4.

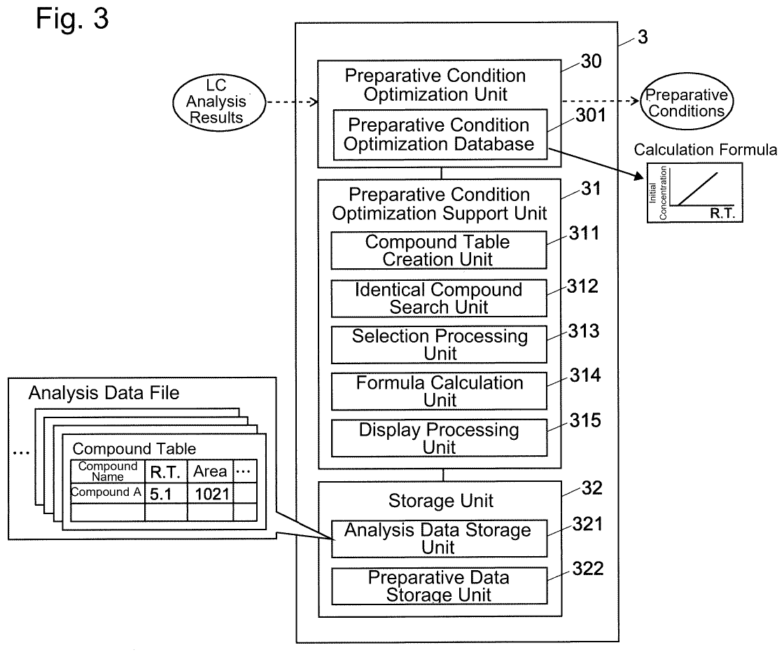

FIG. 3 is a functional block configuration diagram of main parts in the preparative management unit 3. As shown in FIG. 3, the preparative management unit 3 includes a preparative condition optimization unit 30, a preparative condition optimization support unit 31, a storage unit 32, and the like. The preparative condition optimization unit 30 includes a preparative condition optimization database 301 used to find optimal preparative conditions. The preparative condition optimization database 301 includes information on the calculation formula indicating the relationship between the retention time of the compound in the analytical scale LC analysis and the mobile phase initial concentration described above.

The preparative condition optimization support unit 31 includes a compound table creation unit 311, an identical compound search unit 312, a selection processing unit 313, a calculation formula calculation unit 314, and a display processing unit 315. The storage unit 32 includes an analysis data storage unit 321 in which analytical scale LC analysis results are stored, and a preparative data storage unit 322 in which preparative scale LC analysis results are stored. As shown in FIG. 3, the analysis data storage unit 321 stores a plurality of LC analysis data files each for one sample, and each analysis data file includes a compound table in which the retention time, peak area value, etc., for each identified compound are described. Similarly, the preparative data storage unit 322 also stores a plurality of similar LC preparative data files each for one sample.

In the following description, the retention time in analytical scale LC analysis is referred to as “analytical retention time” and is simply described as “R.T.” or “Analytical R.T.” in the drawings. On the other hand, the retention time in preparative scale LC analysis is referred to as “preparative retention time” and is described as “Preparative R.T.” in the drawings.

In this analysis condition determination system, under the control of the control/processing unit 2, analytical scale LC analysis and preparative scale LC analysis are respectively performed on a plurality of compounds by the analysis/preparative unit 1, and LC analysis data files and LC preparative data files containing LC analysis results which are the results thereof are stored in the analysis data storage unit 321 and the preparative data storage unit 322. It is desirable that the plurality of compounds are compounds having relatively similar properties in terms of separation by LC, for example, similar magnitude of affinity for water. This is because compounds having relatively similar properties in terms of LC separation can use a common calculation formula. In other words, for compounds having significantly different properties in terms of LC separation, it is difficult to use a common calculation formula, and as described later, there is a high possibility that it becomes necessary to use different calculation formulas to determine preparative conditions (here, mobile phase initial concentration).

[How to Obtain Calculation Formula Used for Determining Preparative Conditions] Here, first, an example of calculating a calculation formula using a plurality of known compounds whose affinity for water is standard (having neither particular hydrophilicity nor hydrophobicity) as target compounds will be described. Analytical scale and preparative scale LC analysis may be performed on one standard sample containing these plural types of known compounds to acquire LC analysis results for each of the plural types of compounds (hereinafter, analytical scale LC analysis results are referred to as “LC analysis results” and preparative scale LC analysis results are referred to as “LC preparative results”), or a plurality of standard samples each containing one type of compound may be prepared for the plural types of compounds, and analytical scale and preparative scale LC analysis may be performed on the plurality of samples to acquire LC analysis results and LC preparative results for each of the plural types of compounds.

Analytical scale LC analysis is performed using the analytical column 141. That is, when performing analytical scale LC analysis, the flow path switching valves 140 and 143 are switched so that the mobile phase passes through the analytical column 141 and reaches the first detector 16, and in that state, LC analysis is carried out under predetermined gradient conditions. On the other hand, preparative scale LC analysis is performed using the preparative column 142. That is, when performing preparative scale LC analysis, the flow path switching valves 140 and 143 are switched so that the mobile phase passes through the preparative column 142 and reaches the first detector 16, and in that state, LC analysis is carried out under predetermined gradient conditions. The conditions for LC analysis at this time are set to comprehensive conditions applicable to LC analysis of various compounds predetermined by a program, but a person in charge may select conditions according to the compound to be fractionated from among a plurality of prepared analysis conditions.

Further, as described later, when calculating the calculation formula, one LC analysis result is sufficient for one target compound, but at least two LC preparative results are required. Therefore, preparative scale LC analysis is carried out twice or more under different analysis conditions. Specifically, in the preparative scale LC analysis, the mobile phase initial concentration is changed in a plurality of stages, and information on the retention time of the target compound on the chromatogram acquired under each condition is stored in the preparative data storage unit 322 as the LC preparative result.

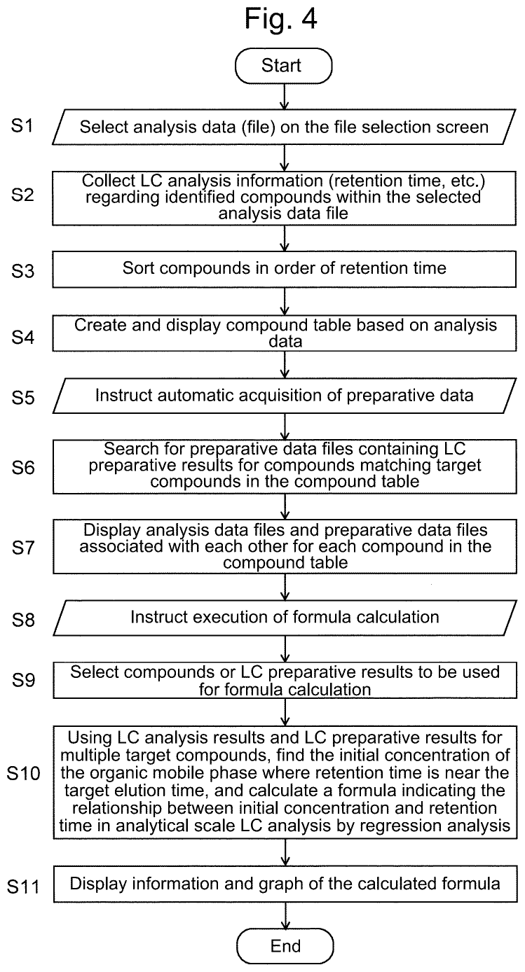

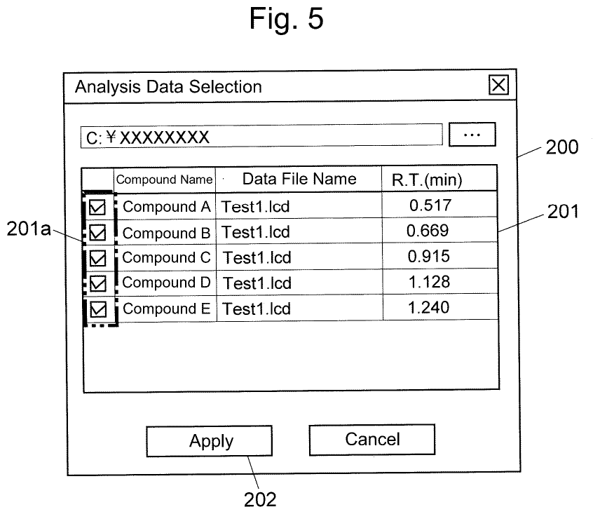

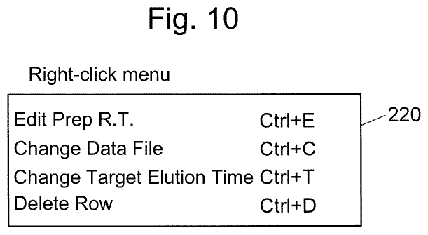

Next, a characteristic operation carried out in the preparative condition optimization support unit 31 based on the data stored in the storage unit 32 will be described with reference to FIGS. 4 to 14. FIG. 4 is a flowchart showing an example of an operation procedure and a processing procedure when the preparative condition optimization support unit 31 obtains the calculation formula, and FIGS. 5 to 14 are diagrams showing display screens and the like during the operation and processing.

When the person in charge performs a predetermined operation from the operation unit 5, the compound table creation unit 311 displays a file selection dialog on the screen of the display unit 6. The file selection dialog can include a list showing a list of analysis data files saved in the analysis data storage unit 321. The person in charge selects one or a plurality of analysis data files corresponding to the target compounds desired to be used for creating the calculation formula on this file list (Step S1). Upon receiving this selection operation, the compound table creation unit 311 acquires information on names of compounds identified in the LC analysis and their analytical retention times (elution times) from the compound table stored in each selected analysis data file (Step S2).

The compound table creation unit 311 sorts the target compounds in the order of the acquired analytical retention times (Step S3) and creates a compound candidate table in which the compound name, the analysis data file name, and the analytical retention time (R.T.) are described in one row for each compound. The display processing unit 315 displays an analysis data selection screen 200 on which a compound candidate table 201 is arranged, as shown in FIG. 5, on the screen of the display unit 6 (Step S4). In the example of FIG. 5, analysis data file names and analytical retention times relating to five target compounds, Compounds A to E, are displayed in the compound candidate table 201.

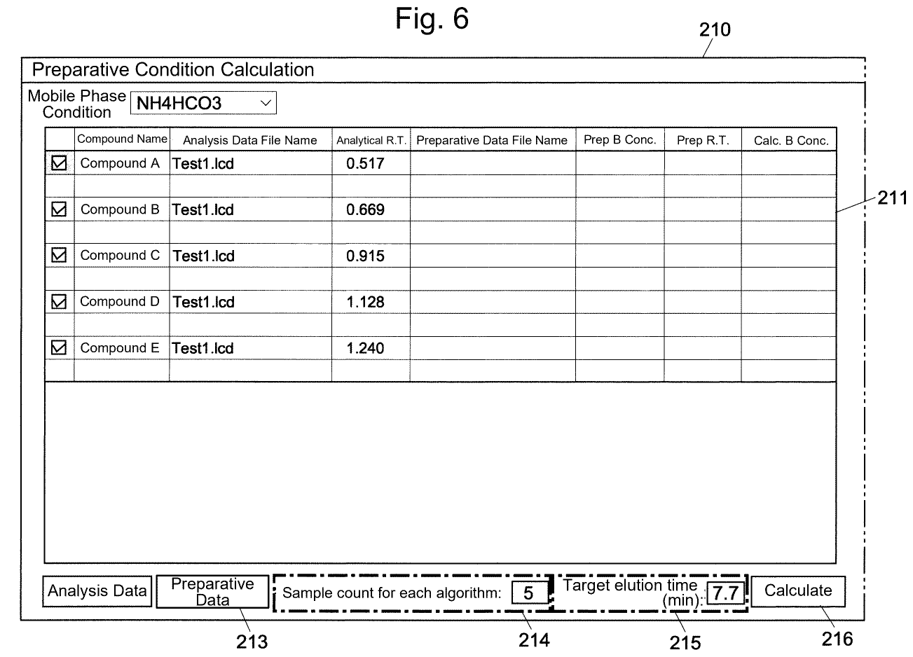

The person in charge visually checks this compound candidate table 201, and if there is no problem, clicks an “Apply” button 202 arranged on the analysis data selection screen 200. On the other hand, if the listed compounds are not appropriate, the person in charge may cancel and select the analysis data files again. Alternatively, if the person in charge wants to exclude some compounds on the compound candidate table 201, the person in charge may perform an operation of unchecking a check box 201a provided in the row of the compound to be excluded on the table 201. When the “Apply” button 202 is clicked, the compound table creation unit 311 fixes the compounds in the compound candidate table 201 displayed at that time (and for which the check box 201a is checked) as target compounds. Along with this, the display processing unit 315 switches the screen on the display unit 6 to a preparative condition calculation screen 210, an example of which is shown in FIG. 6.

On the preparative condition calculation screen 210, a compound table 211 including the fixed target compounds is arranged. Below the compound table 211, a “Preparative Data” button 213, a “Sample Number for Each Algorithm” setting box 214, a “Target Elution Time” setting box 215, a “Calculate” button 216, and the like are arranged. The person in charge sets appropriate numerical values in the setting boxes 214 and 215 as the sample number for each algorithm and the target elution time, respectively. Then, the person in charge instructs automatic acquisition of preparative data by clicking the “Preparative Data” button 213 (Step S5).

Note that the “algorithm” here refers to a calculation method of preparative conditions using a calculation formula, and a specific difference in algorithms is a difference in calculation formulas. Algorithms include a normal algorithm targeting standard compounds, an algorithm targeting highly hydrophobic compounds, an algorithm targeting highly hydrophilic compounds, and the like.

Upon receiving the above instruction, the identical compound search unit 312 searches for a preparative data file containing an LC preparative result for the same compound as the target compound listed in the compound table 211 from the preparative data storage unit 322 (Step S6). Here, as a method for specifying the same compound, either one of the following two methods can be used, or both can be used in combination.

### Method A: Compound Name Search

At the time of creating/registering a preparative data file, the person in charge includes the name of the compound subjected to LC analysis on the preparative scale in the file name. For example, if it is a preparative data file acquired for a standard sample containing “Methylparaben” as a compound, the file name may be set to “Test_NH4HCO3_#01_Methylparaben.lcd” or the like, and such a file naming convention may be established as a rule. The identical compound search unit 312 refers to the file name of the preparative data file, specifies the preparative data file for the same compound as the target compound, and acquires data stored in that preparative data file. That is, in Method A, it can be considered that the analysis data file and the preparative data file are linked by the name of the compound. However, as described above, since one standard sample may contain multiple types of compounds, the correspondence between the analysis data file and the preparative data file is not necessarily one-to-one.

### Method B: Molecular Weight Search

A column for inputting molecular weight for each compound is provided in the compound candidate table 201 on the analysis data selection screen 200 shown in FIG. 5. The person in charge inputs information on known molecular weight for each target compound in this compound candidate table 201. However, if information on molecular weight corresponding to the compound is included in the analysis data file, the identical compound search unit 312 may acquire the information on molecular weight together with the analytical retention time etc., and automatically input it into the column of molecular weight of the compound candidate table 201. Alternatively, a database associating various compounds with molecular weights may be prepared in advance, and information on molecular weight corresponding to the target compound may be automatically acquired using the database and input into the column of molecular weight of the compound candidate table 201. Furthermore, if a mass spectrum acquired by the mass spectrometer which is the second detector 18 during analytical scale LC analysis is included in the analysis data file, information on molecular weight may be automatically extracted from the mass spectrum and input into the column of molecular weight of the compound candidate table 201.

At the time of LC analysis on the preparative scale, a mass spectrum is acquired by the mass spectrometer which is the second detector 18, and the mass spectrum corresponding to the identified compound is stored in the preparative data file. Therefore, each preparative data file includes mass spectrum information. Thus, the identical compound search unit 312 analyzes the mass spectrum in each preparative data file saved in the preparative data storage unit 322 to estimate the molecular weight of the target compound, and specifies a preparative data file containing a compound whose molecular weight matches the target compound within a predetermined tolerance range. Then, it acquires data stored in the specified preparative data file. That is, in this Method B, it can be considered that the analysis data file and the preparative data file are linked by the molecular weight of the compound.

Note that the preparative data file containing the LC preparative result for the compound identical to or estimated to be identical to the target compound can be specified not only by the above two methods but also by other methods. For example, if information specifying the compound, such as the name of the identified compound, is also included in the preparative data file, the identity of the compound can be determined using it. In addition to the compound name, generally available information capable of specifying a compound such as a chemical formula or a CAS registry number may be utilized.

The identical compound search unit 312 specifies a corresponding preparative data file for each of all target compounds listed in the compound table 211 by the procedure described above, and acquires information such as the preparative data file name, LC analysis results such as preparative retention time, and mobile phase initial concentration which is one of the analysis conditions. As described above, since preparative scale LC analysis is performed under a plurality of different analysis conditions (mobile phase initial concentration, etc.) for one compound, at least two or more preparative data files are specified for one target compound, and information regarding those data files is acquired.

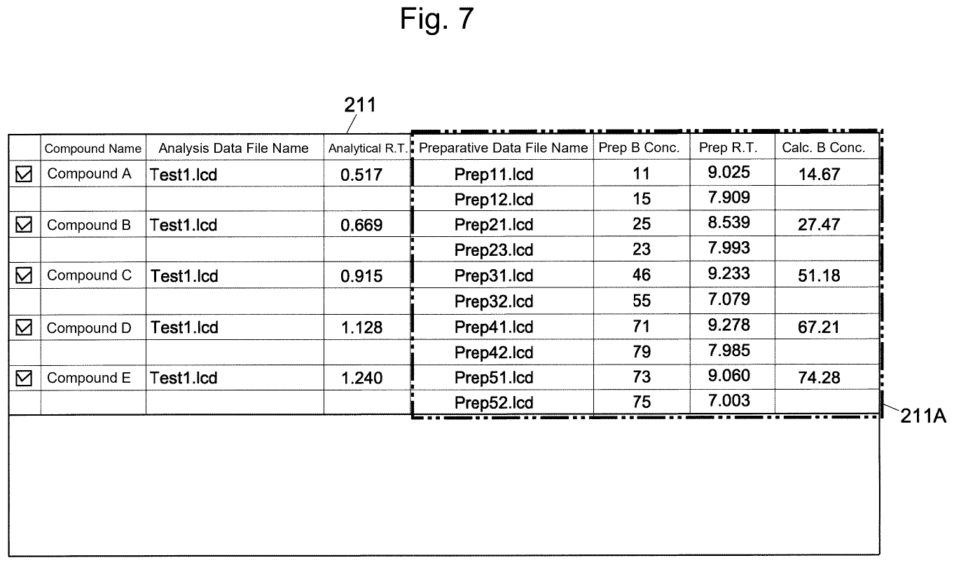

Based on the acquired information, the compound table creation unit 311 automatically inputs the preparative data file name, the mobile phase initial concentration in LC analysis on the preparative scale, and the preparative retention time for each target compound in the compound table 211 on the preparative condition calculation screen 210 (Step S7). FIG. 7 is a diagram showing an example of the compound table 211 to which the preparative data file names and the like have been added based on the search result of the identical compound. In the figure, the added part is indicated by reference numeral 211A. In this example, two LC preparative results are extracted for one target compound. That is, in this compound table 211, since the LC analysis result and the LC preparative result are displayed in a linked state for each target compound, the person in charge can visually check, for example, the relationship between the analytical retention time and the preparative retention time. However, at this point, calculation of the calculation formula described later has not yet been performed, so the “Calc. B Conc.” shown in FIG. 7 is blank.

As described above, there are cases where preparative scale LC analysis is performed under three or more different analysis conditions for one compound, and in such cases, three or more LC preparative results may be extracted for one target compound. FIG. 9 is an example of the compound table 211 in such a case. In this example, four LC preparative results are extracted for each of Compound B and Compound D. Handling of such a case will be described later.

When the analytical retention time which is the LC analysis result and the preparative retention time which is the LC preparative result are ready for each target compound as described above, the person in charge instructs calculation of a calculation formula indicating the relationship between the retention time in analytical scale LC analysis and the mobile phase initial concentration by clicking the “Calculate” button 216 on the preparative condition calculation screen 210 (Step S8).

When obtaining the calculation formula, in principle, one LC analysis result (analytical retention time) and two LC preparative results (preparative retention times) under different conditions are required per compound. Although the number of compounds may be at least two or more, for example, in order to obtain a calculation formula commonly usable for a compound group composed of a plurality of compounds having similar properties, it is desirable to use results for as many compounds included in the compound group as possible for calculating the calculation formula. On the other hand, the compounds initially selected by the person in charge may include compounds unsuitable for calculating the calculation formula, or may include LC preparative results unsuitable for calculating the calculation formula. Therefore, when calculating the calculation formula (or before calculating), selection of compounds or LC preparative results can be performed as follows.

For example, a target compound for which no corresponding preparative data file exists or for which only one corresponding LC preparative result exists is inappropriate as a compound used for calculating the calculation formula. Therefore, for such a target compound, prior to calculation of the calculation formula, the person in charge performs an operation of unchecking the check box at the left end on the compound table 211, whereby the compound can be excluded from the object of calculation of the calculation formula. Alternatively, the selection processing unit 313 may automatically execute exclusion of such compounds (Step S9).

As a specific method for obtaining the calculation formula, the method described in Patent Literature 1 can be used. That is, first, for each target compound, a mobile phase initial concentration (“Calc. B Conc.” in FIG. 6) at which the retention time becomes the target elution time (value set in the “Target Elution Time” setting box 215) is determined. Specifically, when two LC preparative results exist for one target compound as in Compounds A to E shown in FIG. 7, the calculation formula calculation unit 314 calculates the mobile phase initial concentration at which the retention time becomes the target elution time using the two preparative retention times and the actual mobile phase initial concentration in the preparative scale LC analysis (“Prep. B Conc.” in FIG. 6) using an approximate expression shown in the following equation (1).

Y=αX+β (1)
Here, X represents the retention time (elution time), and Y represents the mobile phase initial concentration at that time. α and β are coefficients obtained by substituting the actually measured preparative retention time and mobile phase initial concentration acquired for each target compound. If there are data of at least two or more preparative retention times and mobile phase initial concentrations for each target compound, α and β can be obtained. The value of the mobile phase initial concentration at which the retention time becomes the target elution time is displayed, for example, in the column of “Calc. B Conc.” in the compound table 211 shown in FIG. 7.

Next, a calculation formula indicating the relationship between the analytical retention times of the plurality of (five in the example shown in FIG. 7) target compounds and the mobile phase initial concentration when the retention time becomes the target elution time obtained from the above approximate expression (1) is calculated. This calculation formula can be obtained by creating a graph taking the retention time in analytical scale LC analysis on the X-axis and the initial concentration of the organic mobile phase on the Y-axis as shown in FIG. 15(a), and determining a function (linear function) fitting most appropriately to the graph by regression analysis (Step S10).

When there are three or more LC preparative results (preparative retention times) for one target compound as in Compounds B and D shown in FIG. 9, the mobile phase initial concentration at which the retention time becomes the target elution time may be calculated using all the preparative retention times and mobile phase initial concentrations. Alternatively, for all combinations of selecting two from among three or more LC preparative results, the mobile phase initial concentration when the retention time becomes the target elution time may be calculated respectively, and a combination in which the error (residual) of the function finally obtained by regression analysis is minimized may be selected.

Further, when the number of target compounds listed in the compound table 211 exceeds the sample number specified in the “Sample Number for Each Algorithm” setting box 214, the selection processing unit 313 can perform the following processing to adjust the number of target compounds used for calculating the calculation formula to the specified sample number. That is, for example, when determining the calculation formula by regression analysis, compounds whose plot points on the graph largely deviate from the straight line of the approximate calculation formula can be automatically excluded. In this case, it is preferable to display the numerical value of the calculated B concentration excluded from the calculation in a manner easily distinguishable from other calculated B concentrations, for example, in red characters, on the compound table 211, and automatically uncheck the check box corresponding to the compound.

Alternatively, the selection processing unit 313 may exclude compounds corresponding to biased plot points so that plot points on the graph are distributed as equally spaced as possible on the X-axis or the Y-axis when determining the calculation formula. Also in this case, it is preferable to display the numerical value of the calculated B concentration excluded from the calculation in a manner easily distinguishable from other calculated B concentrations, for example, in red characters, on the compound table 211, or display adopted compounds and unadopted compounds in the compound table 211 in an easily distinguishable manner, and automatically uncheck the check box corresponding to the compound. In this way, by making the intervals of plot points nearly uniform on the graph, it becomes easy to secure the accuracy of the calculation formula.

Further, the selection processing unit 313 may perform the following processing when calculating the calculation formula. It is desirable that the preparative retention times (Prep. R.T.) corresponding to a certain compound used for calculating the calculation formula temporally sandwich the target elution time, that is, are positioned before and after the target elution time, respectively. However, there may be a case where the two preparative retention times are both before or after the target elution time. In that case, the target elution time exists at a position extrapolated from the two preparative retention times, and particularly, the focus gradient for the target compound cannot exhibit sufficient performance, that is, may cause a decrease in purity of the target compound or a decrease in recovery rate of the target compound. Therefore, when the target elution time is at an extrapolated position with respect to preparative retention times for a certain compound, the selection processing unit 313 preferably warns the person in charge of that fact when calculating the calculation formula.

That is, when the “Calculate” button 216 is operated by the person in charge, the selection processing unit 313 determines whether or not the two preparative retention times for each target compound are both located before or after the target elution time at that time. If the two preparative retention times are both located before or after the target elution time, a red “!” mark is displayed in the column of the preparative retention time of that compound on the compound table 211, and a warning message “Error: Extrapolation with respect to target elution time” is pop-up displayed. Thereby, the person in charge can grasp that the accuracy of preparative conditions cannot be guaranteed with the calculation formula calculated based on the values of the preparative retention time at that time, and can avoid performing calculation without noticing that it is extrapolation.

When the warning display as described above appears, the person in charge can resolve the state where the target elution time is extrapolated using one of the following methods.

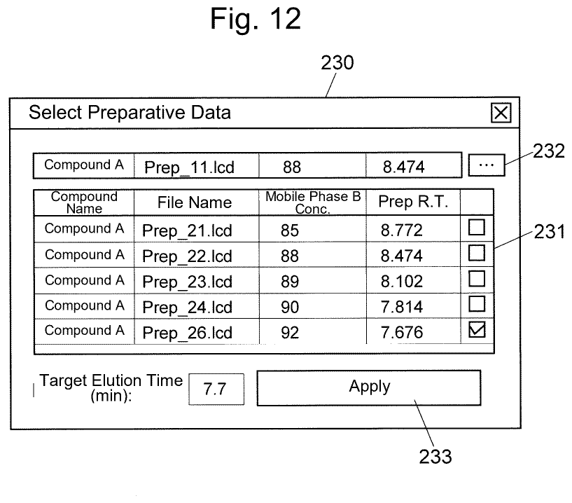

First, when the person in charge performs a right-click operation with the mouse included in the operation unit 5, a right-click menu 220 as shown in FIG. 12 is pop-up displayed on the preparative condition calculation screen 210. The right-click menu 220 has four options: “Edit Prep. R.T.”, “Change Data File”, “Change Target Elution Time”, and “Delete Row”, and the person in charge can select any one of them. Each will be described.

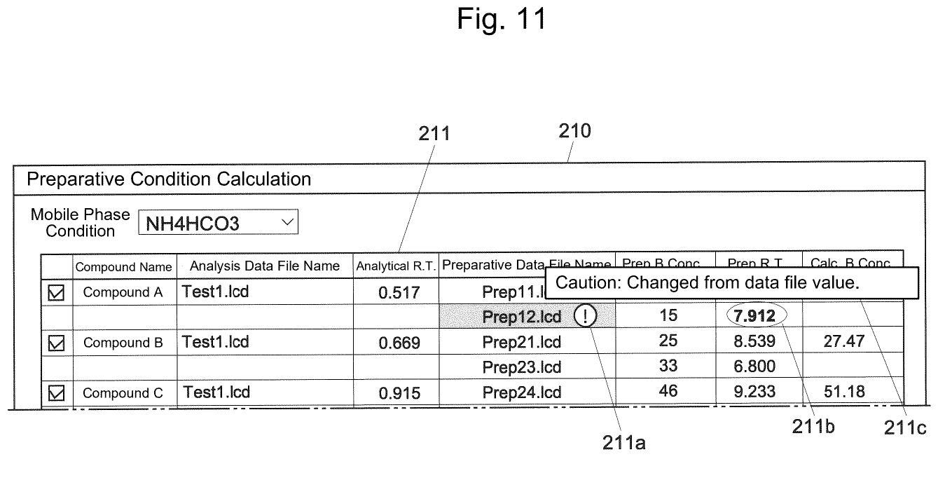

When the person in charge selects “Edit Prep. R.T.” in the right-click menu 220, the calculation formula calculation unit 314 automatically changes the preparative retention time causing extrapolation at that time to a value that does not cause extrapolation. Specifically, for example, the preparative retention time closer to the target elution time is automatically changed to target elution time −0.1 or target elution time +0.1. In order to indicate that the changed value of the preparative retention time is not a value acquired from the preparative data file, the character color is changed from others as shown in FIG. 11, and a warning pop-up display “Caution: Changed from the value in the data file” is temporarily performed. Further, the automatically changed value is made capable of accepting manual input (change) by the person in charge. Thereby, after the value of the preparative retention time is automatically changed, the person in charge can correct the automatically changed value to a more appropriate value at his/her own discretion.

When the person in charge selects “Change Data File” in the right-click menu 220, the calculation formula calculation unit 314 displays a preparative data selection dialog 230 as shown in FIG. 12. In this dialog 230, one piece of data for creating a regression line is displayed in one row. When the person in charge operates a “ . . . ” button 232 located at the right end of this row to select a folder in which preparative data files are stored, the identical compound search unit 312 automatically acquires other preparative data files in which the same compound as in the preparative data file before change is identified, and automatically acquires preparative data (organic mobile phase initial concentration, preparative retention time) contained in the data files. Then, it creates a list 231 of these preparative data and displays it. In the example of FIG. 12, five new preparative data files and preparative data therein are listed.

The person in charge checks this list 231, puts a check mark on data capable of interpolating the target elution time, and then clicks an “Apply” button 233. The compound table creation unit 311 accepts this operation and reflects the numerical values such as the preparative retention time of the instructed row in the compound table 211 of the main preparative condition calculation screen 210. Thereby, an appropriate preparative data file can be selected such that the preparative retention time is in an interpolated state with respect to the target elution time.

When the person in charge selects “Change Target Elution Time” in the right-click menu 220, the calculation formula calculation unit 314 automatically inputs a value with which the preparative retention time does not become extrapolation for all compounds in the compound table 211 as a recommended value into the “Target Elution Time” setting box 215 of the preparative condition calculation screen 210. This automatically input value can be manually edited by the person in charge.

When the person in charge selects “Delete Row” in the right-click menu 220, the calculation formula calculation unit 314 automatically deletes the row (compound) causing extrapolation in the compound table 211. Thereafter, the person in charge performs an operation of manually adding a new preparative data file as necessary. Note that if the “Calculate” button 216 is clicked without adding a preparative data file, a calculation formula is created with the number of compounds reflected in the calculation formula reduced.

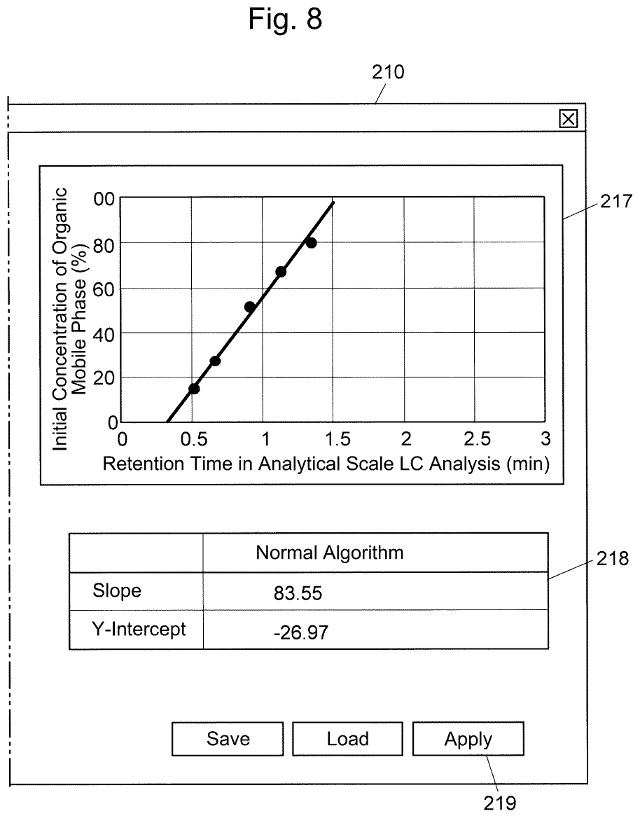

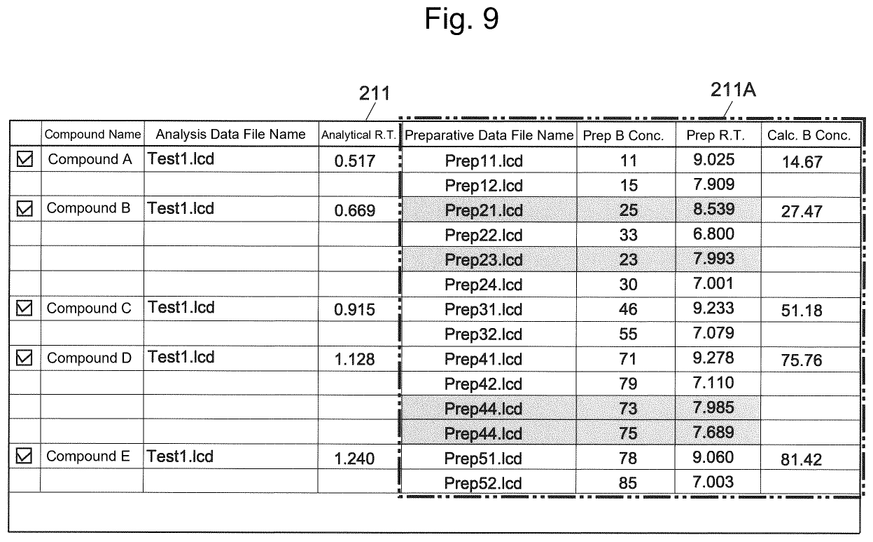

As described above, when the calculation formula indicating the relationship between the retention time in analytical scale LC analysis and the mobile phase initial concentration when the retention time becomes the target elution time is obtained, the display processing unit 315 displays a graph 217 representing this calculation formula in the upper right part of the preparative condition calculation screen 210 as shown in FIG. 8. Further, below the graph 217, numerical information of the calculation formula corresponding to the graph 217 is displayed in a table 218. In this case, the table 218 includes numerical values of the slope of the straight line on the graph 217 and the Y-intercept (Step S11). When the person in charge clicks an “Apply” button 219 in this state, the calculated calculation formula is fixed, and this calculation formula is registered in the preparative condition optimization database 301. Using this registered calculation formula, it becomes possible to determine preparative conditions when fractionating a target compound.

That is, when determining preparative conditions in the preparative condition determination system shown in FIG. 1, LC analysis is executed on a standard sample containing a target compound to be fractionated using the analytical column 141 under predetermined analysis conditions. The control/processing unit 2 creates a chromatogram based on data collected in this LC analysis, detects a peak corresponding to the target compound on the chromatogram, and obtains a retention time. In the preparative management unit 3, the preparative condition optimization unit 30 obtains an initial concentration value of the organic mobile phase capable of fractionating the target compound at the target elution time using the above calculation formula included in the preparative condition optimization database 301. As shown in FIG. 15(b), for example, when the actually measured retention time of the target compound is t0, the value of the mobile phase initial concentration capable of fractionating the target compound at the target elution time is obtained as Cb0 from the calculation formula. Then, gradient conditions changing as shown by the solid line in FIG. 15(a) with that value Cb0 as the initial concentration can be obtained. By performing component separation by the preparative LC apparatus shown in FIG. 2 based on the preparative conditions determined in this way, the target compound can be fractionated and purified in the vicinity of the target elution time.

As described above, in the preparative condition determination system, the calculation formula indicating the relationship between the retention time in analytical scale LC analysis and the initial concentration of the organic mobile phase used when determining gradient conditions, which are one of the preparative conditions, can be created by simple work and put into a state usable for preparative condition determination work.

In particular, in the conventional system as described in Non-Patent Literature 1, since an expert having specialized knowledge was assumed as a person who performs a series of operations for creating this calculation formula, work such as searching for LC analysis results and LC preparative results used for creating the calculation formula and inputting those data, or correcting or replacing LC preparative results when the calculation formula is inappropriate or expected to be inappropriate, was very complicated. In contrast, according to the system proposed here, such work can be considerably simplified, and work efficiency can be improved. In addition, even a person with insufficient knowledge or little experience regarding LC analysis can handle the work, and for example, the work of creating the calculation formula can be easily performed even on the apparatus user side. Furthermore, since it is possible to prevent creating a calculation formula using inappropriate data, the accuracy of the calculation formula is improved, and the recovery rate and purity when fractionating and purifying the target compound can be improved.

### Modifications

In the above description, an example of changing gradient conditions as preparative conditions has been described, but other preparative conditions such as the flow velocity (or flow rate) of the mobile phase, the injection amount of the sample, and the capacity of the column may be changed. Of course, not only one but a plurality of preparative conditions may be changed.

In the above description, the relationship between the retention time in analytical scale LC analysis and the initial concentration of the organic mobile phase during fractionation is represented by one calculation formula as shown in the graph 217 in FIG. 8 or the graph in FIG. 15(b), but a plurality of calculation formulas may be used according to the properties and characteristics of the target compound. In other words, not only the normal algorithm represented by numerical values in the table 218 shown in FIG. 8 but also different algorithms may be selectively used.

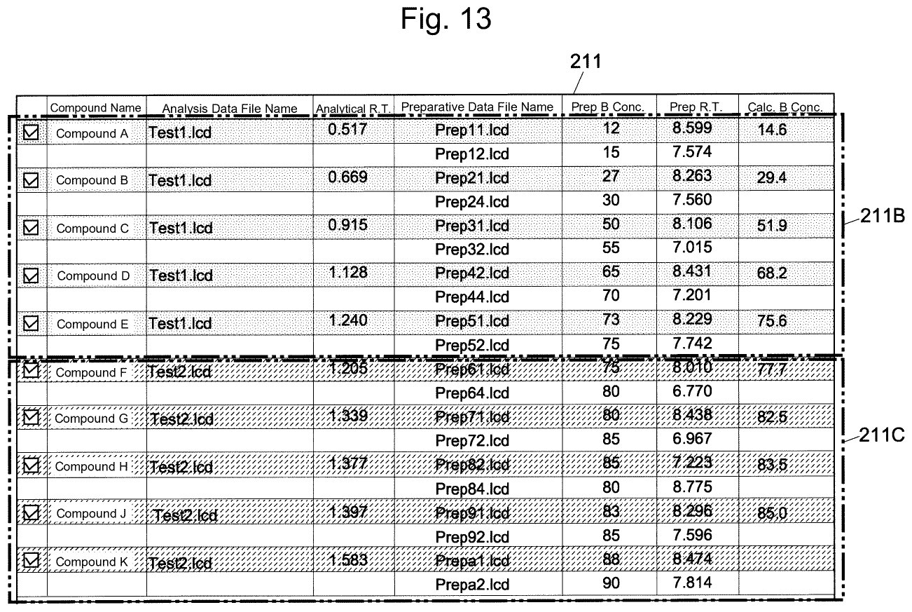

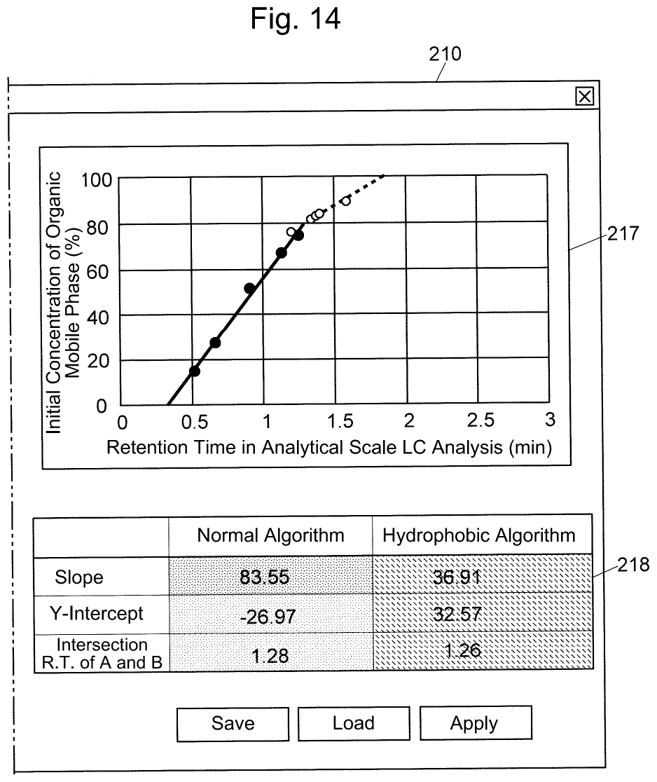

Specifically, the calculation formula by the normal algorithm targets compounds whose magnitude of affinity for water is standard, but calculation formulas for extremely highly hydrophilic and/or extremely highly hydrophobic compounds may be created separately. As an example, a case where a calculation formula by a hydrophobic algorithm targeting extremely highly hydrophobic compounds is created in addition to the normal algorithm will be described with reference to FIGS. 13 and 14.

In this case, when selecting target compounds desired to be used for creating the calculation formula, the person in charge selects, for example, other Compounds F, G, H, J, and K having extremely high hydrophobicity in addition to Compounds A, B, C, D, and E having standard affinity for water. FIG. 13 shows an example of the compound table 211 created by automatically acquiring LC preparative results in that case. In FIG. 13, reference numeral 211B indicates data relating to a compound group having standard affinity for water, while reference numeral 211C indicates data relating to a compound group having extremely high hydrophobicity.

In this case, calculation of the calculation formula by the procedure described above is performed for each compound group having different properties, and a calculation formula corresponding to each is calculated. As a result, a graph 217 and a table 218 as shown in FIG. 14 are displayed on the right side of the preparative condition calculation screen 210. In the graph 217, black circle plots are plots indicating mobile phase initial concentrations corresponding to the compound group having standard hydrophilicity (Compounds A, B, C, D, E), and an approximate straight line shown by a solid line is calculated from these plots. On the other hand, white circle plots are plots indicating mobile phase initial concentrations corresponding to the compound group having extremely high hydrophobicity (Compounds F, G, H, J, K), and an approximate straight line shown by a dotted line is calculated from these plots. In the table 218, the slope and Y-intercept of each calculation formula are indicated by numerical values, and the retention time corresponding to the intersection of the two approximate straight lines is also indicated.

When a plurality of calculation formulas (algorithms) are registered in the preparative condition optimization database 301 in this way, the initial concentration of the mobile phase during fractionation may be obtained from the actually measured retention time in analytical scale LC analysis using any one of the plurality of calculation formulas according to the property of the compound to be fractionated. Thereby, more appropriate preparative conditions according to the property of the compound can be determined.

Furthermore, the above embodiment and the modifications described above are merely examples of the present invention, and it is obvious that further changes, additions, deletions, etc. made within the scope of the gist of the present invention are also included in the scope of claims of the present application.

### Various Aspects

Those skilled in the art will understand that the above-described exemplary embodiment is a specific example of the following aspects.

(Item 1) One aspect of the LC management system according to the present invention is a management system for acquiring information used when determining analysis conditions for operating an LC apparatus, comprising: a first storage unit configured to save one or a plurality of first analysis result files containing a first analysis result acquired by subjecting a predetermined sample containing one or a plurality of compounds to LC analysis under a first analysis condition; a second storage unit configured to save a plurality of second analysis result files containing a second analysis result acquired by subjecting a predetermined sample containing one or a plurality of compounds to LC analysis under a second analysis condition in which a mobile phase flow rate or a sample injection amount is larger than in the first analysis condition; a search unit configured to search for the second analysis result associated with the same compound as a compound associated with the first analysis result in the first analysis result file saved in the first storage unit, from the second analysis result files saved in the second storage unit; an association information creation unit configured to create association information associating the first analysis result with the second analysis result or associating the first analysis result file with the second analysis result file, for each compound, based on a search result by the search unit; and a display processing unit configured to display the association information on a display screen.

(Item 2) One aspect of the LC management method according to the present invention is a management method for acquiring information used when determining analysis conditions for operating a liquid chromatograph apparatus using a computer, wherein the computer executes: a first step of saving one or a plurality of first analysis result files containing a first analysis result acquired by subjecting a predetermined sample containing one or a plurality of compounds to liquid chromatograph analysis under a first analysis condition; a second step of saving a plurality of second analysis result files containing a second analysis result acquired by subjecting a predetermined sample containing one or a plurality of compounds to liquid chromatograph analysis under a second analysis condition in which a mobile phase flow rate or a sample injection amount is larger than in the first analysis condition; a third step of searching for the second analysis result associated with the same compound as a compound associated with the first analysis result in the first analysis result file, from the second analysis result files; a fourth step of creating association information associating the first analysis result with the second analysis result or associating the first analysis result file with the second analysis result file, for each compound, based on a result of the search; and a fifth step of displaying the association information on a display screen.

In the LC management system according to Item 1 and the LC management method according to Item 2, LC includes preparative LC. The first and second analysis conditions are conditions affecting separation performance in LC, and can include, for example, one or a plurality of the type of column (type of packing material, particle size, etc.), column dimensions (inner diameter, length), type of mobile phase, flow velocity (flow rate) of mobile phase, sample injection amount, column temperature, gradient conditions, and the like. The first and second analysis results may contain various information corresponding to compounds in the sample obtained by data acquired by a detector of the LC or data processing based thereon. For example, in addition to elution time (retention time), peak area (or height), etc., when the detector is a mass spectrometer, information such as a mass spectrum obtained at the elution time of the compound or a molecular weight obtained from the mass spectrum can be used as the first and second analysis results.

In the LC management system according to Item 1 and the LC management method according to Item 2, work of searching for a first analysis result and a second analysis result for the same compound acquired under mutually different analysis conditions and associating and displaying them is automated, making it unnecessary for a person in charge to perform such work personally. Further, the person in charge can easily compare the first analysis result and the second analysis result for the same compound based on the association information displayed on the display screen. Thereby, according to the LC management system according to Item 1 and the LC management method according to Item 2, it is possible to simplify the work of the person in charge when acquiring, for example, a calculation formula used for determining appropriate preparative conditions by scale-up or information corresponding thereto, improve work efficiency thereof, reduce work errors, and enable setting of more appropriate preparative conditions.

(Item 3) In the LC management method according to Item 2, at least one of the first analysis result and the second analysis result includes a mass spectrum, and in the third step, the computer may determine identity between the compound associated with the first analysis result and the compound associated with the second analysis result by comparison between mass spectra or comparison between a molecular weight estimated from a mass spectrum and information on molecular weight for each compound.

In the LC management method according to Item 3, since the identity of compounds is determined based on information such as peak patterns of mass spectra or molecular weights, even if compound names are unknown, it is possible to acquire information on compounds highly likely to be identical and display association information.

(Item 4) In the LC management method according to Item 2, in the third step, the computer may determine identity between the compound associated with the first analysis result and the compound associated with the second analysis result using information specifying compounds contained in the first analysis result file and the second analysis result file, respectively.

Here, “information” “contained in the first analysis result file and the second analysis result file, respectively” refers to all information related to the files, such as file names for identifying the files and attributes of the files, as well as data stored in the files. Further, “information specifying a compound” is typically a compound name, but may be any information capable of specifying individual compounds, such as a CAS registry number or a chemical formula.

In the LC management method according to Item 3 described above, information on mass spectra is required for determining the identity of compounds, and it is necessary to use an apparatus using a mass spectrometer as a detector when acquiring data. In contrast, in the LC management method according to Item 4, since the identity of compounds is determined using information specifying compounds such as compound names, information on molecular weights of compounds is not required, and it is applicable to an apparatus using an ultraviolet-visible spectrophotometer or the like as a detector.

(Item 5) In the LC management method according to any one of Items 2 to 4, the first analysis condition may be an analysis condition in liquid chromatograph analysis using a normal analytical column, and the second analysis condition may be an analysis condition in liquid chromatograph analysis using a preparative column.

According to the LC management method described in Item 5, it is possible to easily determine preparative conditions capable of appropriately implementing scale-up from an analytical scale to a preparative scale for performing fractionation and purification of a large amount of target compound.

(Item 6) In the LC management method according to any one of Items 2 to 5, the plurality of second analysis result files are acquired by performing liquid chromatograph analysis on the same compound under a plurality of mutually different second analysis conditions, and the computer may search for a plurality of the second analysis results associated with one compound in the third step, and create a list table associating the first analysis result with the plurality of second analysis results for each compound as the association information in the fourth step.

(Item 7) In the LC management method according to Item 6, the first analysis result and the second analysis result may include information on retention time, and the list table may include a retention time under the first analysis condition and a plurality of retention times under the second analysis condition for each compound.

In the LC management method according to Item 7, since a plurality of retention times under different analysis conditions are associated with one compound, it is possible to estimate a second analysis condition such that the retention time becomes a certain target elution time using information on the plurality of retention times. Then, by using the result, it is possible to acquire information such as a calculation formula indicating the relationship between the retention time in LC analysis under the first analysis condition and the second analysis condition, and based on the information, it becomes possible to obtain the second analysis condition for scaling up from an actual LC analysis result under the first analysis condition.

(Item 8) In the LC management method according to Item 6 or 7, the first analysis condition and the second analysis condition may each include information on an initial concentration of one mobile phase in gradient separation, and the list table may include at least the initial concentration of the one mobile phase in the second analysis condition.

According to the LC management method described in Item 8, for example, it is possible to estimate an initial concentration of a mobile phase at which the retention time becomes a certain target elution time under a condition where the mobile phase flow rate is larger or the sample injection amount is larger than in the first analysis condition, for each compound. Thereby, it is possible to acquire information such as a calculation formula indicating the relationship between the retention time in LC analysis under the first analysis condition and the initial concentration of the mobile phase, and based on the information, it is possible to obtain the initial concentration of the mobile phase for scaling up from an actual LC analysis result under the first analysis condition.

(Item 9) In the LC management method according to any one of Items 6 to 8, the computer may further execute a step of setting a target retention time regarding a preparative target compound, and in the fourth step, when three or more retention times under the second analysis condition are associated with one compound, show two retention times selected by leaving, when there are a plurality of retention times positioned temporally before or after the target retention time, only the retention time closer to the target retention time, such that the two retention times respectively positioned temporally before and after the target retention time sandwiching the target retention time are identifiable from other retention times on the list table.

According to the LC management method described in Item 9, when estimating a second analysis condition, for example, an initial concentration of a mobile phase, at which the retention time becomes a set target retention time, the estimation accuracy can be improved. Thereby, the accuracy of information such as a calculation formula indicating the relationship between the retention time in LC analysis under the first analysis condition and the second analysis condition used for determining the second analysis condition at the time of scale-up is also increased, and for example, a target compound can be fractionated and purified with a higher recovery rate and purity.

(Item 10) In the LC management method according to Item 9, the computer may display the target retention time together with the list table on the display screen in the fifth step. Also, the computer may enable the target retention time displayed on the display screen to be changed according to an operation by a person in charge in the fifth step.

According to the LC management method described in Item 10, the person in charge can compare the target retention time set at that time with the retention time which is the LC analysis result under the second analysis condition on the display screen, and easily determine whether or not the latter is appropriate data.

(Item 11) In the LC management method according to any one of Items 6 to 10, the computer may further execute a step of creating a graph reflecting a relationship between analysis conditions and analysis results using the first analysis result and the plurality of second analysis results associated with all or specified one or plurality of compounds listed in the list table, and display the graph together with the list table on the display screen in the fifth step.

Here, the graph reflecting the relationship between analysis conditions and analysis results is, for example, a graph showing the relationship between the retention time in LC analysis under the first analysis condition and the initial concentration of the mobile phase. According to the LC management method described in Item 11, for example, the person in charge can check a calculation formula indicating the relationship between the retention time in LC analysis under the first analysis condition and the initial concentration of the mobile phase, which is used for determining preparative conditions, in a graph format, and easily determine whether or not the calculation formula is appropriate.

(Item 12) In the LC management method according to Item 9 or 10, the computer may further execute a step of setting a target retention time regarding a preparative target compound, determine whether or not all of the retention times under the second analysis condition associated with one compound are positioned temporally before or after the target retention time in the fourth step, and perform a warning display on the list table when it is determined that all of the retention times under the second analysis condition are positioned temporally before or after the target retention time in the fifth step.

When all of the retention times under the second analysis condition associated with one compound are positioned temporally before or after the target retention time, it is necessary to perform prediction by extrapolation to obtain the second analysis condition at which the retention time becomes the target retention time, and it is inevitable that the accuracy of the prediction decreases compared to interpolation. In contrast, according to the LC management method described in Item 12, it is possible to inform the person in charge in advance that prediction by extrapolation will be performed, and the person in charge can avoid prediction by extrapolation by taking appropriate measures such as changing the target retention time as necessary. Thereby, for example, the accuracy of a calculation formula indicating the relationship between the retention time in LC analysis under the first analysis condition and the initial concentration of the mobile phase can be increased, and preparative conditions based on the calculation formula can also be made more appropriate.

### Reference Signs List

1, 1A . . . Analysis/preparative unit
10a, 10b . . . Mobile phase container
11a, 11b . . . Liquid sending pump
12 . . . Mixer
13 . . . Injector
14 . . . Separation column unit
140, 143 . . . Flow path switching valve
141 . . . Analytical column
142 . . . Preparative column
15 . . . Splitter
16 . . . First detector
17 . . . Fraction collector
170 . . . Preparative unit
171 . . . Preparative valve
172 . . . Preparative nozzle
173 . . . Preparative container
174 . . . Preparative control unit
18 . . . Second detector
2, 2A . . . Control/processing unit
3 . . . Preparative management unit
30 . . . Preparative condition optimization unit
301 . . . Preparative condition optimization database
31 . . . Preparative condition optimization support unit
311 . . . Compound table creation unit
312 . . . Identical compound search unit
313 . . . Selection processing unit
314 . . . Calculation formula calculation unit
315 . . . Display processing unit
32 . . . Storage unit
321 . . . Analysis data storage unit
322 . . . Preparative data storage unit
4 . . . Computer 5 . . . Operation unit
6 . . . Display unit

1. A management system for acquiring information used when determining analysis conditions for operating a liquid chromatograph apparatus, comprising: a first storage unit configured to save one or a plurality of first analysis result files containing a first analysis result acquired by subjecting a predetermined sample containing one or a plurality of compounds to liquid chromatograph analysis under a first analysis condition;
a second storage unit configured to save a plurality of second analysis result files containing a second analysis result acquired by subjecting a predetermined sample containing one or a plurality of compounds to liquid chromatograph analysis under a second analysis condition in which a mobile phase flow rate or a sample injection amount is larger than in the first analysis condition; a search unit configured to search for the second analysis result associated with the same compound as a compound associated with the first analysis result in the first analysis result file saved in the first storage unit, from the second analysis result files saved in the second storage unit; an association information creation unit configured to create association information associating the first analysis result with the second analysis result or associating the first analysis result file with the second analysis result file, for each compound, based on a search result by the search unit; and a display processing unit configured to display the association information on a display screen.

2. A management method for a liquid chromatograph for acquiring information used when determining analysis conditions for operating a liquid chromatograph apparatus using a computer, wherein the computer executes: a first step of saving one or a plurality of first analysis result files containing a first analysis result acquired by subjecting a predetermined sample containing one or a plurality of compounds to liquid chromatograph analysis under a first analysis condition; a second step of saving a plurality of second analysis result files containing a second analysis result acquired by subjecting a predetermined sample containing one or a plurality of compounds to liquid chromatograph analysis under a second analysis condition in which a mobile phase flow rate or a sample injection amount is larger than in the first analysis condition; a third step of searching for the second analysis result associated with the same compound as a compound associated with the first analysis result in the first analysis result file, from the second analysis result files; a fourth step of creating association information associating the first analysis result with the second analysis result or associating the first analysis result file with the second analysis result file, for each compound, based on a result of the search; and a fifth step of displaying the association information on a display screen.

3. The management method for a liquid chromatograph according to claim 2, wherein at least one of the first analysis result and the second analysis result includes a mass spectrum, and the computer determines identity between the compound associated with the first analysis result and the compound associated with the second analysis result by comparison between mass spectra or comparison between a molecular weight estimated from a mass spectrum and information on molecular weight for each compound in the third step.

4. The management method for a liquid chromatograph according to claim 2, wherein the computer determines identity between the compound associated with the first analysis result and the compound associated with the second analysis result using information specifying compounds contained in the first analysis result file and the second analysis result file, respectively, in the third step.

5. The management method for a liquid chromatograph according to claim 2, wherein the first analysis condition is an analysis condition in liquid chromatograph analysis using a normal analytical column, and the second analysis condition is an analysis condition in liquid chromatograph analysis using a preparative column.

6. The management method for a liquid chromatograph according to claim 2, wherein the plurality of second analysis result files are acquired by performing liquid chromatograph analysis on the same compound under a plurality of mutually different second analysis conditions, and the computer searches for a plurality of the second analysis results associated with one compound in the third step, and creates a list table associating the first analysis result with the plurality of second analysis results for each compound as the association information in the fourth step.

7. The management method for a liquid chromatograph according to claim 6, wherein the first analysis result and the second analysis result include information on retention time, and the list table includes a retention time under the first analysis condition and a plurality of retention times under the second analysis condition for each compound.

8. The management method for a liquid chromatograph according to claim 7, wherein the first analysis condition and the second analysis condition each include information on an initial concentration of one mobile phase in gradient separation, and the list table includes at least the initial concentration of the one mobile phase in the second analysis condition.

9. The management method for a liquid chromatograph according to claim 7, wherein the computer further executes a step of setting a target retention time regarding a preparative target compound, and in the fourth step, when three or more retention times under the second analysis condition are associated with one compound, shows two retention times selected by leaving, when there are a plurality of retention times positioned temporally before or after the target retention time, only the retention time closer to the target retention time, such that the two retention times respectively positioned temporally before and after the target retention time sandwiching the target retention time are identifiable from other retention times on the list table.

10. The management method for a liquid chromatograph according to claim 9, wherein the computer displays the target retention time together with the list table on the display screen in the fifth step.

11. The management method for a liquid chromatograph according to claim 6, wherein the computer further executes a step of creating a graph reflecting a relationship between analysis conditions and analysis results using the first analysis result and the plurality of second analysis results associated with all or specified one or plurality of compounds listed in the list table, and displays the graph together with the list table on the display screen in the fifth step.

12. The management method for a liquid chromatograph according to claim 7, wherein the computer further executes a step of setting a target retention time regarding a preparative target compound, determines whether or not all of the retention times under the second analysis condition associated with one compound are positioned temporally before or after the target retention time in the fourth step, and performs a warning display on the list table when it is determined that all of the retention times under the second analysis condition are positioned temporally before or after the target retention time in the fifth step.
